(19) United States
(12) Patent Application Publication
(10) Pub. No.: US 2012/0170288 A1
(43) Pub. Date: Jul. 5, 2012

(54) LIGHT EMITTING DIODE LAMP AND METHOD FOR FABRICATING THE SAME

(75) Inventors: Kou-Rueh Lai, Hsinchu City (TW); Tung-Hsing Tsou, Hsinchu County (TW); Ren-Zong Chen, Taoyuan County (TW)

(73) Assignee: NOVALITE OPTRONICS CORP., Hsinchu City (TW)

(21) Appl. No.: 13/244,670

(22) Filed: Sep. 25, 2011

Related U.S. Application Data
(63) Continuation-in-part of application No. 13/110,002, filed on May 18, 2011.
(60) Provisional application No. 61/428,873, filed on Dec. 31, 2010.

(30) Foreign Application Priority Data
Feb. 25, 2011 (TW) 100106503

(51) Int. Cl. F21V 29/00; H01J 9/00

(52) U.S. Cl. 362/373; 445/23

(57) ABSTRACT

A structure of a light emitting diode (LED) lamp and a method for fabricating the same are provided. In the structure of the LED lamp, LEDs are designed to approach an inner surface of a lampshade more closely, so that the LED lamp has high brightness and high light-utilization efficiency. The above-mentioned structure and method facilitate the mass-production of the LED lamp.

### CROSS-REFERENCE TO RELATED APPLICATION

This is a continuation-in-part application of and claims the priority benefit of patent application Ser. No. 13/110,002, filed on May 18, 2011, which claims the priority benefits of U.S. provisional application Ser. No. 61/428,873, filed on Dec. 31, 2010 and Taiwan application serial no. 100106503, filed Feb. 25, 2011, now pending. The entirety of each of the above-mentioned patent applications is hereby incorporated by reference herein and made a part of this specification.

### BACKGROUND OF THE INVENTION

1. Technical Field

The disclosure is related to a lamp and a method for fabricating the same, and in particular to a light emitting diode (LED) lamp and a method for fabricating the same.

2. Background

Since Thomas Edison invented the incandescent lamp, electric lighting has been widely used in the world. Nowadays, high-brightness and durable lighting devices such as the fluorescent lamp have also been developed. Compared with the incandescent lamp, the fluorescent lamp has advantages such as high efficiency and a low operating temperature. However, heavy metals (mercury) are included in the fluorescent lamp, causing damage to the environment when disposed of.

As lighting technology advances, LED light bars, a type of light source that is more energy-efficient and environment-friendly, have been developed. LEDs in LED light bars utilize recombination of electrons and holes in P-N junctions to generate light. Compared with the incandescent lamp, LED light bars have advantages such as lower power consumption and long life spans. Moreover, LED light bars do not require mercury and are more environment-friendly.

In order to promote LED light bars as a light source for everyday use (such as indoor lighting equipment or outdoor lighting equipment), sockets of LED lamps need to be designed as the same as or compatible with sockets of current light bulbs, so that LED lamps may be directly installed in current lamp bases, thereby increasing public willingness to use LED lamps. However, current LED lamps have problems such as less-than-expected light emitting uniformity and low light-utilization efficiency.

FIG. 1 is a schematic diagram showing a conventional LED lamp. Please refer to FIG. 1. A conventional technology of an LED lamp is as follows. An LED element is designed to be fixed near a same surface of a lamp socket. Although the lamp has a light focusing effect, a light emitting angle by the conventional technology is only (less than) 180 degrees. When used for indoor lighting, it cannot replace a incandescent light bulb. Moreover, the conventional technology also uses weighty metal materials, such as aluminum. This not only increases the amount of resources consumed from the Earth, thus not being in line with the goal of energy and carbon emission reduction, but also increases the risk of massive lamps falling and hurting people. FIG. 2 is a schematic diagram showing another conventional LED lamp. Please refer to FIG. 2, the conventional technology of the other LED provides a lamp with a 360-degree light emitting angle. However, in the convention technology, a hard substrate is used to fix the LED at a central position of the lamp, and the LED is limited by the dimensions of the socket of the lamp, so that the LED is away from the lampshade, has a low light emitting efficiency, and has inferior applicability.

### SUMMARY OF THE INVENTION

In light of the above, the disclosure provides a LED lamp and method for fabricating the LED lamp. The LED lamp fabricated according to this method has greater light emitting uniformity and higher light-utilization efficiency.

The disclosure provides an LED lamp which has superb light emitting uniformity and high brightness.

The disclosure provides a light emitting diode (LED) lamp including a lamp main body, a thermal conductive holder, and a flexible LED light source. The lamp main body includes a socket and a lampshade, wherein the lamp main body defines an accommodating space. The thermal conductive holder is disposed in the accommodating space and fixed on the socket. The flexible LED light source is disposed in the accommodating space and assembled on the thermal conductive holder. The flexible LED light source includes a single flexible circuit board and a plurality of LED packages. The single flexible circuit board includes a single flexible carrier and a plurality of electrical conductive traces on the single flexible carrier, wherein the single flexible carrier includes a central portion fixed on a top of the thermal conductive holder and a plurality of extending portions extending outwardly from the central portion, each of the extending portions is bent toward a bottom of the thermal conductive holder, and the LED packages are mounted on the single flexible carrier and electrically connected to the electrical conductive traces.

In an embodiment of the present application, the material of the thermal conductive holder includes metal or nonmetal.

In an embodiment of the present application, the thermal conductive holder includes a pillar and a base, wherein the pillar includes an upper fixing portion, the base is connected to a bottom of the pillar, and the central portion of the single flexible carrier is fixed on the upper fixing portion of the pillar.

In an embodiment of the present application, the upper fixing portion is a spheroid, and each of the extending portions is bent along a surface of the spheroid.

In an embodiment of the present application, the single flexible carrier has an assembly hole located at the central portion, the upper fixing portion is a spheroid having a fixing hole, each of the extending portions is bent along a surface of the spheroid, and the fixing element passes through the assembly hole and is fixed in the fixing hole.

In an embodiment of the present application, the fixing element is a screw and the fixing hole is a threaded hole.

In an embodiment of the present application, the LED lamp further includes a thermal conductive coating coated on the thermal conductive holder.

In an embodiment of the present application, the LED lamp further comprises a confinement element encircling the thermal conductive holder and binding the extending portions on the thermal conductive holder.

In an embodiment of the present application, a maximum distance between any two extending portions is 1 to 3 times a minimum opening diameter of the lampshade.

In an embodiment of the present application, the single flexible circuit board further comprises a thermal conductive layer, the single flexible carrier has a front surface and a rear surface, the thermal conductive layer is disposed on the rear surface while the electrical conductive traces and the LED packages are disposed on the front surface.

The disclosure provides a method for fabricating a light emitting diode (LED) lamp, comprising: providing a thermal conductive holder; providing a flexible LED light source, the flexible LED light source comprising a single flexible circuit board and a plurality of LED packages, the single flexible circuit board comprising a single flexible carrier and a plurality of electrical conductive traces on the single flexible carrier, the single flexible carrier comprising a central portion fixed on a top of the thermal conductive holder and a plurality of extending portions extending outwardly from the central portion, and each of the extending portions being bent toward a bottom of the thermal conductive holder; and the plurality of LED packages being mounted on the single flexible carrier and electrically connected to the electrical conductive traces; assembling the central portion on the thermal conductive holder and bending the extending portions to approach the thermal conductive holder; inserting the flexible LED light source and the thermal conductive holder into the lampshade, wherein the extending portions are bent outward to approach an inner surface of the lampshade after the flexible LED light source and the thermal conductive holder are inserted into the lampshade; and assembling the thermal conductive holder and the lampshade on a socket.

In summary, in the method for fabricating the LED lamp according to the disclosure, by first assembling the flexible LED light source on the thermal conductive holder and then inserting the flexible LED light source and the thermal conductive holder into the lampshade, the flexible LED light source is closer to the inner surface of the lampshade and is bent along the inner surface. Therefore, the LED lamp fabricated according to the fabricating method of the disclosure has higher light-utilization efficiency and greater light emitting uniformity.

In order to make the aforementioned and other objects, features and advantages of the disclosure comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

The accompanying drawings are included to provide a further understanding of the disclosure, and are incorporated in and constitute a part of this specification. The drawings illustrate embodiments of the disclosure and, together with the description, serve to explain the principles of the disclosure.

FIGS. 1 and 2 are each a schematic diagram showing a conventional LED lamp.

FIG. 3 is a schematic fabrication flowchart of an LED lamp according to an embodiment of the disclosure.

FIG. 4 schematically illustrates the LED lamp according to an embodiment of the disclosure.

FIG. 5 schematically illustrates the thermal conductive holder of the LED lamp according to an embodiment of the disclosure.

FIG. 6 schematically illustrates the LED lamp during assembling according to an embodiment of the disclosure.

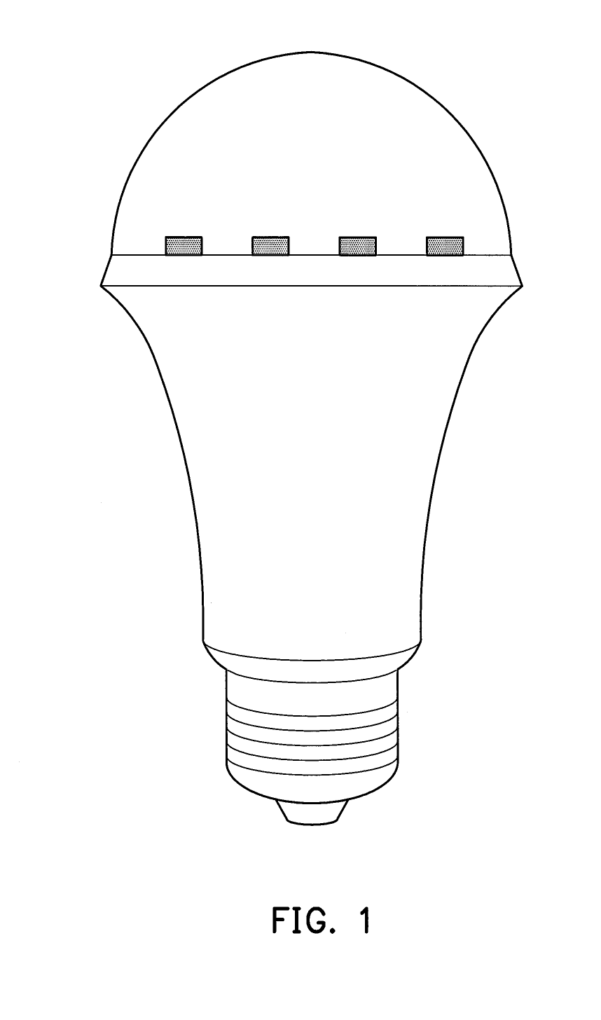

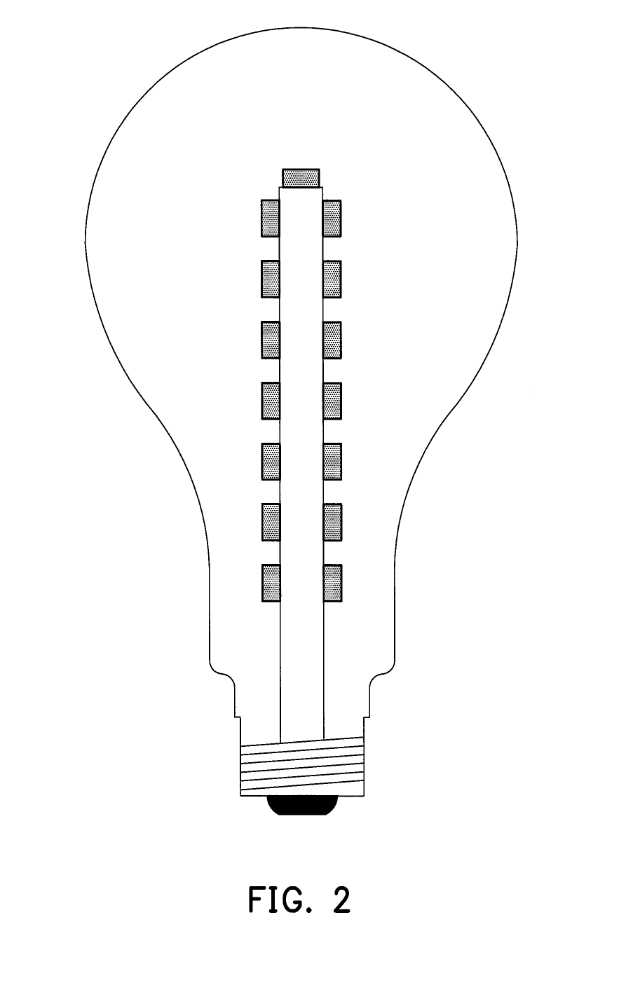

### DETAILED DESCRIPTION OF DISCLOSED EMBODIMENTS

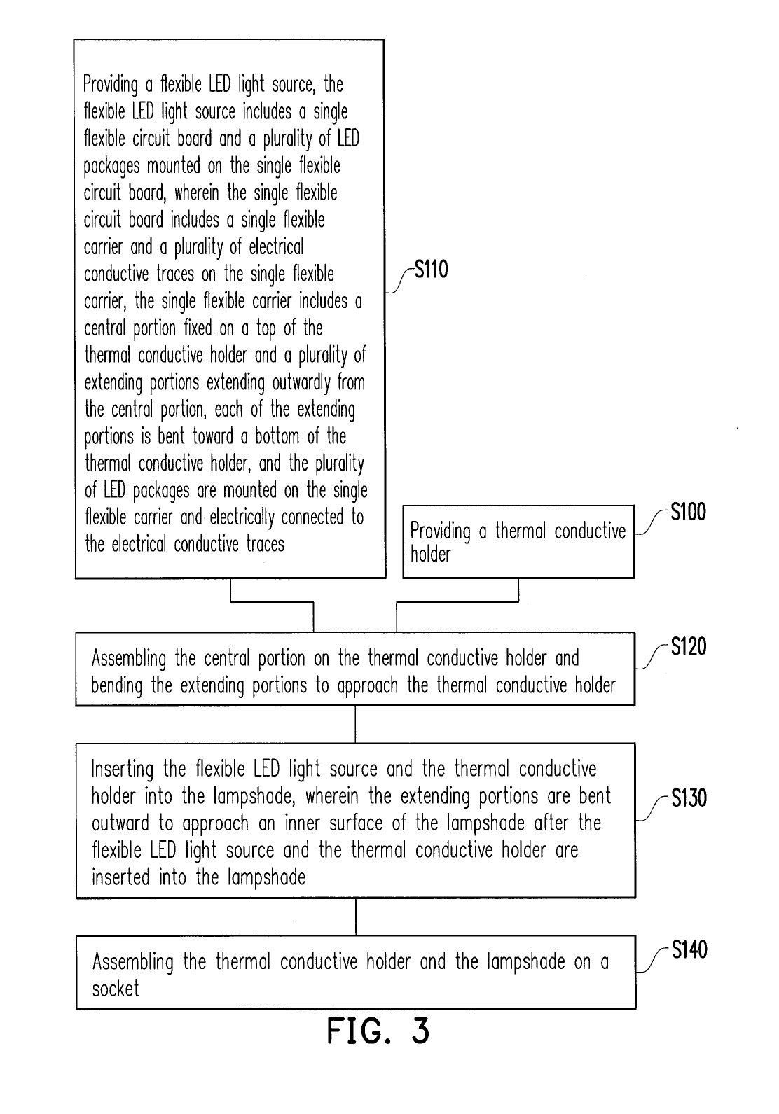

FIG. 3 is a schematic fabrication flowchart of an LED lamp according to an embodiment of the disclosure. Please refer to FIG. 3. A method for fabricating an LED lamp according to the present embodiment includes: providing a thermal conductive holder (step S100); providing a flexible LED light source, the flexible LED light source includes a single flexible circuit board and a plurality of LED packages mounted on the single flexible circuit board, wherein the single flexible circuit board includes a single flexible carrier and a plurality of electrical conductive traces on the single flexible carrier, the single flexible carrier includes a central portion fixed on a top of the thermal conductive holder and a plurality of extending portions extending outwardly from the central portion, each of the extending portions is bent toward a bottom of the thermal conductive holder, and the plurality of LED packages are mounted on the single flexible carrier and electrically connected to the electrical conductive traces (step S110); assembling the central portion on the thermal conductive holder and bending the extending portions to approach the thermal conductive holder (step S120); inserting the flexible LED light source and the thermal conductive holder into the lampshade, wherein the extending portions are bent outward to approach an inner surface of the lampshade after the flexible LED light source and the thermal conductive holder are inserted into the lampshade (step S130); and assembling the thermal conductive holder and the lampshade on a socket (step S140).

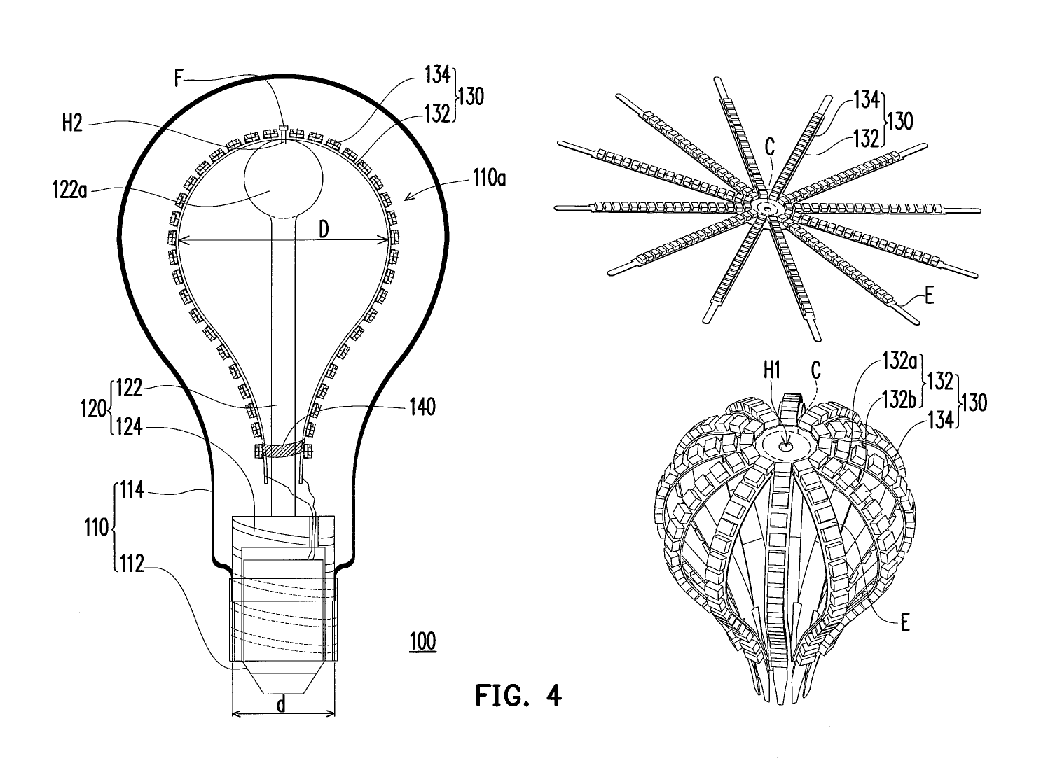

After the above-mentioned steps (step S100 through step 140) are performed, the LED lamp 100 is accomplished and the structure of the LED lamp 100 is schematically illustrated in FIG. 4.

Referring to FIG. 4, the LED lamp 100 of this embodiment includes a lamp main body 110, a thermal conductive holder 120, and a flexible LED light source 130. The lamp main body 110 includes a socket 112 and a lampshade 114, wherein the lamp main body 110 defines an accommodating space 110a. The thermal conductive holder 120 is disposed in the accommodating space 110a and fixed on the socket 112. The flexible LED light source 130 is disposed in the accommodating space 110a and assembled on the thermal conductive holder 120. The flexible LED light source 130 includes a single flexible circuit board 132 and a plurality of LED packages 134. The single flexible circuit board 132 includes a single flexible carrier 132a and a plurality of electrical conductive traces 132b on the single flexible carrier 132a, wherein the single flexible carrier 132a includes a central portion C fixed on the top of the thermal conductive holder 120 and a plurality of extending portions E extending outwardly from the central portion C, each of the extending portions E is bent toward the bottom of the thermal conductive holder 120, and the LED packages 134 are mounted on the single flexible carrier 132a and electrically connected to the electrical conductive traces 132b.

The socket of the lamp main body 110 of this embodiment may have different appearance and dimension, one ordinary skilled in the art may choose adequate socket base on design requirements. In addition, the lampshade 114 may be of any appearance and dimension.

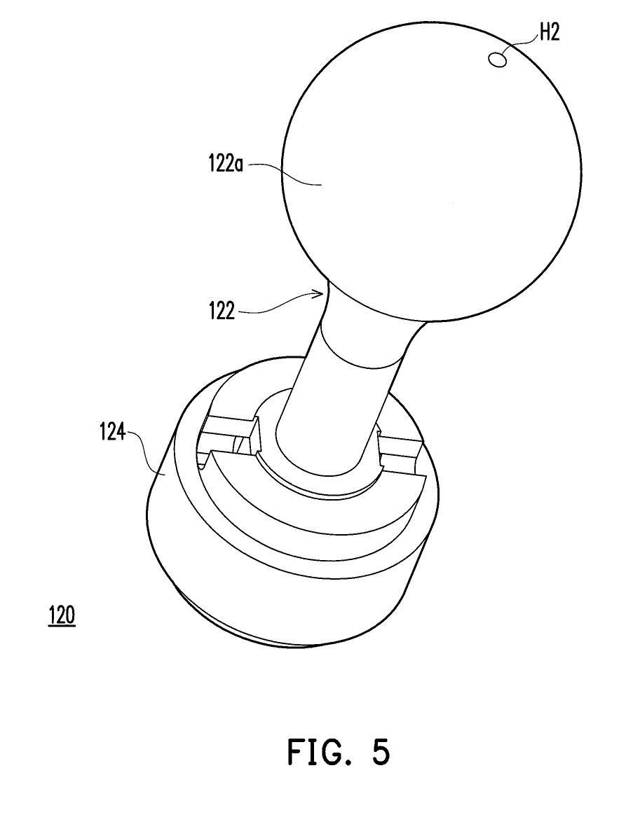

FIG. 5 schematically illustrates the thermal conductive holder of the LED lamp according to an embodiment of the disclosure. Referring to FIG. 4 and FIG. 5, the thermal conductive holder 120 of this embodiment includes a pillar 122 and a base 124, wherein the pillar 122 includes an upper fixing portion 122a, and the base 124 is physically connected to a bottom of the pillar 122. In this embodiment, the upper fixing portion 122a of the pillar 122 is a spheroid, for example. As shown in FIG. 4, the central portion C of the single flexible carrier 132a is fixed on the upper fixing portion 122a of the pillar 122, and each of the extending portions E is bent along a surface of the spheroid. In other words, each of the extending portions E is bent downwardly and is bent toward the base 124 of the thermal conductive holder 120.

In an alternate embodiment of the present application, the single flexible carrier 132a has an assembly hole H1 located at the central portion C, the upper fixing portion 122a of the pillar 122 is a spheroid having a fixing hole H2, each of the extending portions E is bent along a surface of the spheroid (122a), and a fixing element F passes through the assembly hole H1 and is fixed in the fixing hole H2. For example, the fixing element F is a screw and the fixing hole H2 is a threaded hole.

It is noted that the appearance and dimension of the upper fixing portion 122a can be properly modified by one ordinary skilled in the art so as to fit the inner appearance and the inner dimension of the lampshade 114 (as shown in FIG. 4). In this embodiment, the material of the thermal conductive holder 120 is metal or nonmetal, for example. The material of the thermal conductive holder 120 may be any material that has superb thermal conductivity.

In a preferred embodiment of the present application, the LED lamp 100 may optionally includes a thermal conductive coating (not shown) that is coated on the outer surface of the thermal conductive holder 120 so as to enhance the thermal conductivity of the thermal conductive holder 120. The above-mentioned thermal conductive coating may be any material that has superb thermal conductivity.

Referring to FIG. 4, according to this embodiment, a driving current control circuit (not shown) electrically connected to the flexible LED light source 130 may be equipped in the thermal conductive holder 120 or other position within the accommodating space 110a. Moreover, the driving current control circuit may be electrically connected to the flexible LED light source 130 through wires or other conductive means so as to control the current transmitted to the flexible LED light source 130. More specifically, the electrical conductive traces 132b may be distributed at an end of each extending portion E such that the flexible LED light source 130 may be electrically connected to the driving current control circuit through the above-mentioned wires and the electrical conductive traces 132b.

Referring to FIG. 4 again, the LED lamp 100 of the present application may optionally includes a confinement element 140 encircling the thermal conductive holder 120 and binding the extending portions E on the thermal conductive holder 120. More specifically, the extending portions E are bound on the base 124 of the thermal conductive holder 120, the confinement element 140 may be an elastic element.

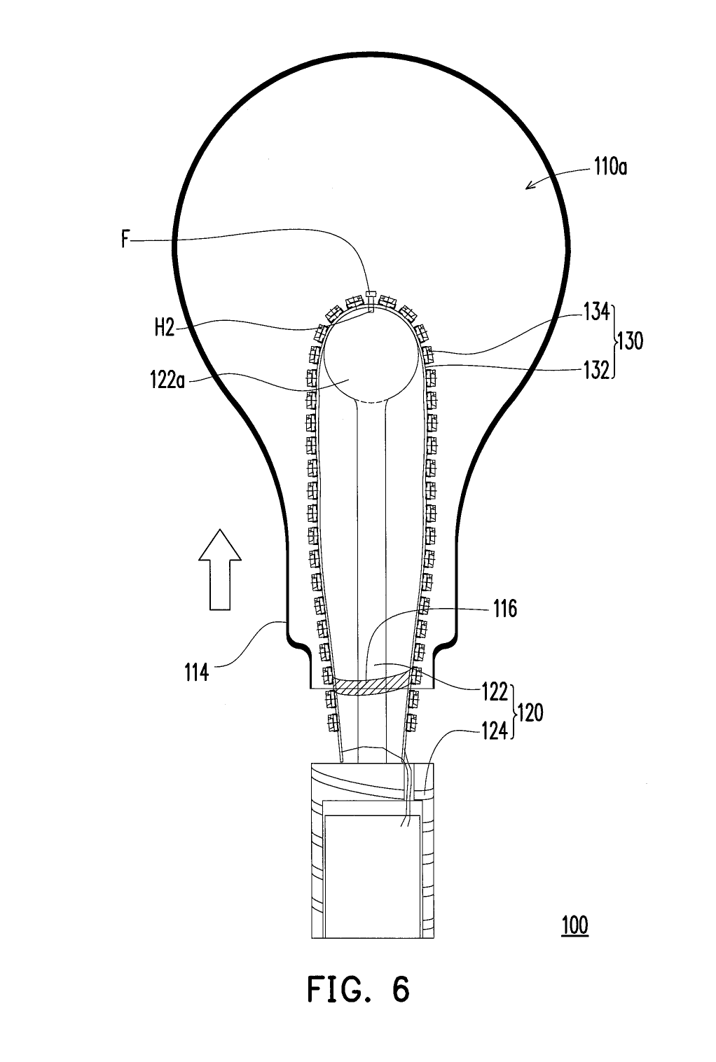

The bending degree of the extending portions E can be well controlled by adjusting the relative position of the thermal conductive holder 120 and the confinement element 140. When the thermal conductive holder 120 and the flexible LED light source 130 are ready to be inserted into the lampshade 114, the flexible LED light source 130 is forced to approach the thermal conductive holder 120 by pulling the extending portions E downwardly (as shown in FIG. 6). After the thermal conductive holder 120 and the flexible LED light source 130 are almost inserted into the lampshade 114, the flexible LED light source 130 are bent outward to approach an inner surface of the lampshade 114 by pushing the extending portions E upwardly.

In this embodiment, after the thermal conductive holder 120 and the flexible LED light source 130 are assembled into the lampshade 114, a maximum distance D between any two extending portions E is 1 to 3 times a minimum opening diameter d of the lampshade 114.

In order to enhance the thermal conductivity of the flexible LED light source 130 and the thermal transmission between the flexible LED light source 130 and the thermal conductive holder 120, a thermal conductive layer (not shown) may used in the flexible LED light source 130. Specifically, the single flexible carrier 132a has a front surface and a rear surface, wherein the thermal conductive layer may be disposed on a rear surface of the single flexible carrier 132a while the electrical conductive traces 132b and the LED packages 134 are disposed on the front surface of the single flexible carrier 132a.

It will be apparent to those skilled in the art that various modifications and variations can be made to the disclosure without departing from the scope or spirit of the disclosure. In view of the foregoing, it is intended that the disclosure cover modifications and variations of this disclosure provided they fall within the scope of the following claims and their equivalents.

What is claimed is:

1. A light emitting diode (LED) lamp, comprising:
a lamp main body, comprising a socket and a lampshade, wherein the lamp main body defines an accommodating space;
a thermal conductive holder, disposed in the accommodating space and fixed on the socket;
a flexible LED light source, disposed in the accommodating space and assembled on the thermal conductive holder, the flexible LED light source comprising:
a single flexible circuit board comprising a single flexible carrier and a plurality of electrical conductive traces on the single flexible carrier, the single flexible carrier comprising a central portion fixed on a top of the thermal conductive holder and a plurality of extending portions extending outwardly from the central portion, and each of the extending portions being bent toward a bottom of the thermal conductive holder; and
a plurality of LED packages, mounted on the single flexible carrier and electrically connected to the electrical conductive traces.

2. The LED lamp as claimed in claim 1, wherein a material of the thermal conductive holder comprises metal or nonmetal.

3. The LED lamp as claimed in claim 1, wherein the thermal conductive holder comprises:
a pillar, comprising an upper fixing portion; and
a base, connected to a bottom of the pillar, the central portion of the single flexible carrier being fixed on the upper fixing portion of the pillar.

4. The LED lamp as claimed in claim 3, wherein the upper fixing portion is a spheroid, and each of the extending portions is bent along a surface of the spheroid.

5. The LED lamp as claimed in claim 3, further comprising a fixing element, wherein the single flexible carrier has an assembly hole located at the central portion, the upper fixing portion is a spheroid having a fixing hole, each of the extending portions is bent along a surface of the spheroid, and the fixing element passes through the assembly hole and is fixed in the fixing hole.

6. The LED lamp as claimed in claim 5, wherein the fixing element is a screw and the fixing hole is a threaded hole.

7. The LED lamp as claimed in claim 1, further comprising a thermal conductive coating coated on the thermal conductive holder.

8. The LED lamp as claimed in claim 1, further comprising a confinement element, encircling the thermal conductive holder and binding the extending portions on the thermal conductive holder.

9. The LED lamp as claimed in claim 1, wherein a maximum distance between any two extending portions is 1 to 3 times a minimum opening diameter of the lampshade.

10. The LED lamp as claimed in claim 1, wherein the single flexible circuit board further comprises a thermal conductive layer, the single flexible carrier has a front surface and a rear surface, the thermal conductive layer is disposed on the rear surface while the electrical conductive traces and the LED packages are disposed on the front surface.

11. A method for fabricating a light emitting diode (LED) lamp, comprising:
providing a thermal conductive holder;
providing a flexible LED light source, the flexible LED light source comprising:
a single flexible circuit board comprising a single flexible carrier and a plurality of electrical conductive traces on the single flexible carrier, the single flexible carrier comprising a central portion fixed on a top of the thermal conductive holder and a plurality of extending portions extending outwardly from the central portion, and each of the extending portions being bent toward a bottom of the thermal conductive holder; and
a plurality of LED packages, mounted on the single flexible carrier and electrically connected to the electrical conductive traces;
assembling the central portion on the thermal conductive holder and bending the extending portions to approach the thermal conductive holder;
inserting the flexible LED light source and the thermal conductive holder into the lampshade, wherein the extending portions are bent outward to approach an inner surface of the lampshade after the flexible LED light source and the thermal conductive holder are inserted into the lampshade; and
assembling the thermal conductive holder and the lampshade on a socket.

12. The method for fabricating the LED lamp as claimed in claim 11, wherein after the flexible LED light bar is bent outward to approach the inner surface of the lampshade, a maximum distance between any two flexible LED light bars is 1 to 3 times a minimum opening diameter of the lampshade.
